(19) United States
(12) Patent Application Publication
(10) Pub. No.: US 2014/0254087 A1
(43) Pub. Date: Sep. 11, 2014

(54) ELECTRONIC DEVICE WITH HARD DISK DRIVE

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventor: XIU-QUAN HU, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/060,615

(22) Filed: Oct. 23, 2013

(30) Foreign Application Priority Data
Mar. 7, 2013 (CN) 2013100716549

(51) Int. Cl. G06F 1/18

(52) U.S. Cl. CPC G06F 1/187
USPC 361/679.34; 361/679.33

(57) ABSTRACT

An electronic device includes a chassis, a circuit board mounted in the chassis, a hard disk drive, a cover secured to the chassis, and a mounting plate secured to the hard disk drive. The mounting plate secures the hard disk drive to the cover adjacent to the circuit board. The cover covers the circuit board and protects components on the circuit board below the cover.

### BACKGROUND

1. Technical Field

The present disclosure relates to electronic devices, and particularly to an electronic device with a hard disk drive.

2. Description of Related Art

A traditional electronic device, such as a computer or a server, includes a circuit board (such as a motherboard), a bracket, and a hard disk drive secured to the bracket. A number of electronic components, such as connectors, are mounted on the circuit board. The connectors can be used for connecting cables, such as power cables and data cables. However, the bracket used for securing the hard disk drive cannot protect the electronic components. The electronic components on the circuit board can be scratched or damaged when securing or removing other electronic components adjacent to the circuit board. Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of one embodiment of an electronic device.

FIG. 2 is an exploded, isometric view of a hard disk drive, a mounting plate, a locking member, and a shock absorbing member of the electronic device of FIG. 1.

FIG. 3 is an assembled, isometric view of the hard disk drive, the mounting plate, the locking member, and the shock absorbing member of the electronic device of FIG. 1.

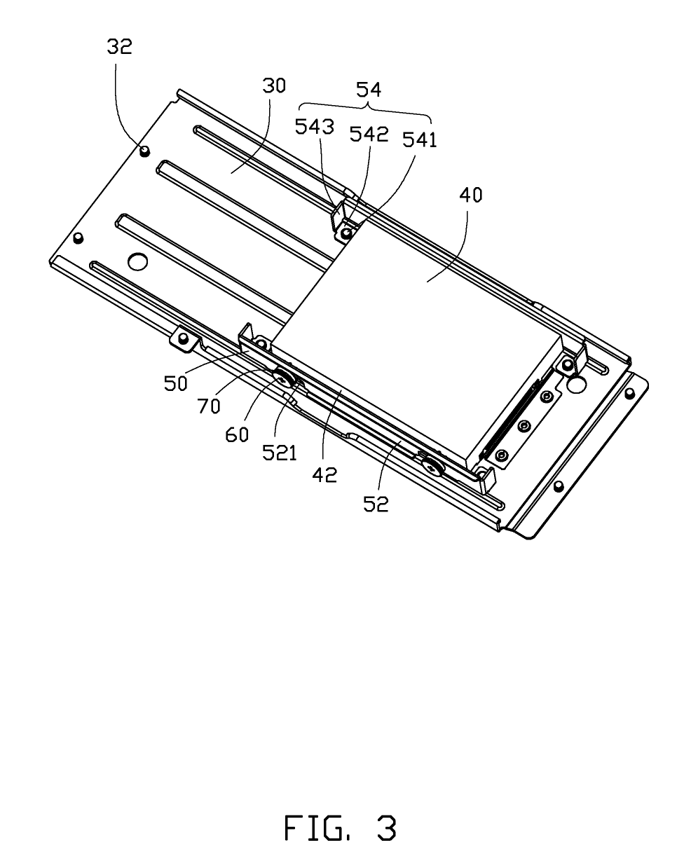

FIG. 4 is an assembled, isometric view of the electronic device of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

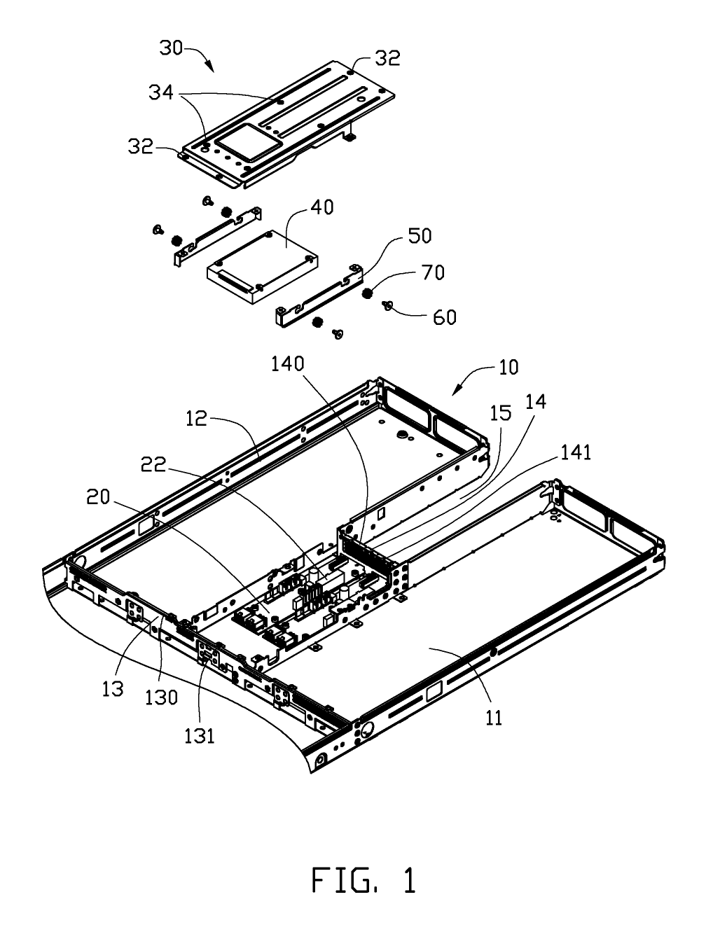

FIG. 1 shows one embodiment of an electronic device. The electronic device includes a chassis 10, a cover 30, a hard disk drive 40, a pair of mounting plates 50, two pairs of mounting members 60, and two pairs of shock absorbing members 70.

The chassis 10 includes a bottom plate 11, two side plates 12 extending from opposite edges of the bottom plate 11, and an installation plate 13 secured between the two side plates 12. In one embodiment, the bottom plate 11 is substantially perpendicular to each side plate 12, and the installation plate 13 is substantially perpendicular to each side plate 12. A distance between the two side plates 12 is substantially equal to a length of the installation plate 13. The bottom plate 11 defines a cutout 15 extending from a side edge of the bottom plate 11. The cutout 15 includes two first side edges, which are substantially parallel to the side plates 12, and a second side edge, which is substantially parallel to the installation plate 13. A connecting plate 14 extends substantially perpendicularly from the second side edge. A length of the connecting plate 14 is smaller than a length of the installation plate 13, and a width of the connecting plate 14 is substantially equal to a width of the installation plate 13. Two circuit boards 20 are secured to the bottom plate 11 and located between the installation plate 13 and the connecting plate 14. A connector 22 is secured to each circuit board 20 for connecting power cables or other cables. Other components, such as capacitors (not shown) are secured to the circuit board 20. The installation plate 13 includes a top edge 130. The top edge 130 of the installation plate 13 defines two first mounting holes 131 for securing the cover 30. A top edge 140 of the connecting plate 14 defines two second mounting holes 141 for securing the cover 30.

The cover 30 is substantially rectangular. A length of the cover 30 is substantially equal to a distance between the installation plate 13 and the connecting plate 14, and a width of the cover 30 is substantially equal to a length of the connecting plate 14. Each of first two ends of the cover 30 defines two first locking holes 32. Each of second two ends of the cover 30 defines two second locking holes 34.

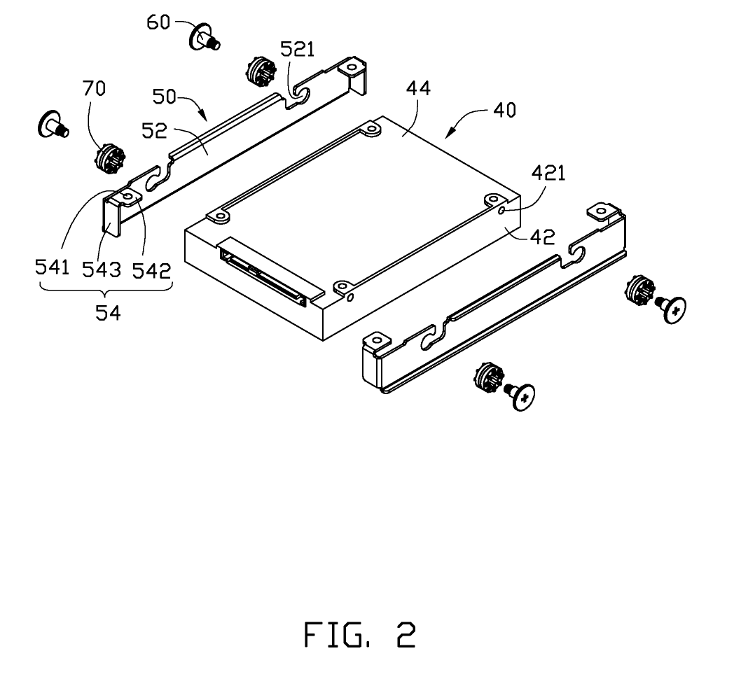

FIG. 2 shows the hard disk drive 40 including two sidewalls 42 and a top wall 44 connected to the two sidewalls 42. Each sidewall 42 defines two installation holes 421.

Each mounting plate 50 includes a main body 52 and two mounting pieces 54 extending from opposite ends of the main body 52. Each mounting piece 54 is substantially “L” shaped and includes a first portion 543 extending from a side edge of the main body 52 and a second portion 542 extending from a top edge of the first portion 543. The first portion 543 and the second portion 542 are substantially perpendicular to the main body 52. The second portion 542 defines a securing hole 541. The main body 52 defines two installation slots 521 corresponding to the installation holes 421.

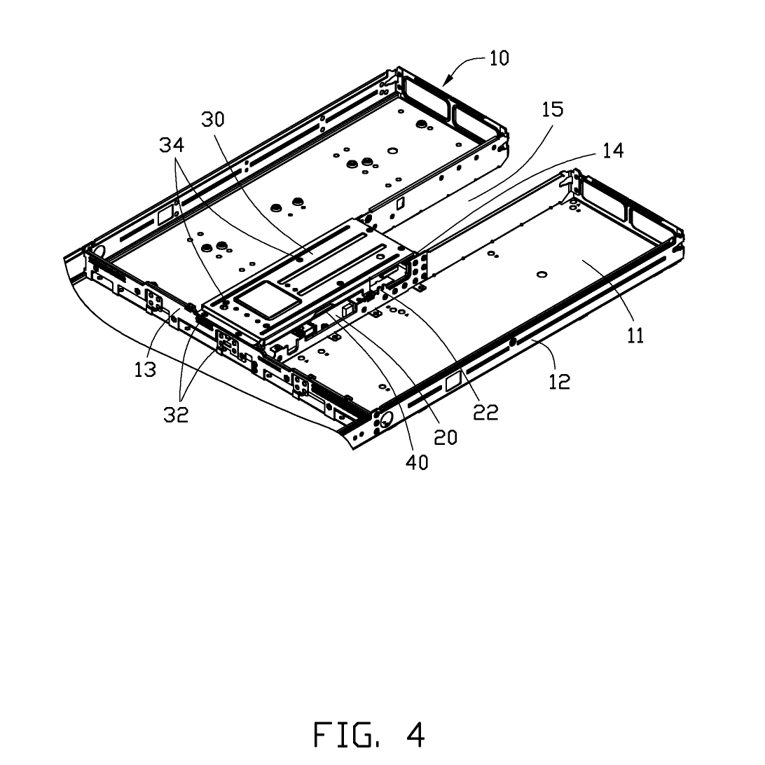

FIGS. 4 and 5 show that in assembly, the mounting plate 50 is moved to the hard disk drive 40 with the installation slot 521 aligned with the installation hole 421. The mounting member 60 is inserted through the shock absorbing member 70, the installation slot 521, and the installation hole 421, to secure the mounting plate 50 to the sidewall 42. Each mounting piece 54 does not touch the hard disk drive 40. The securing hole 541 is aligned with the second locking hole 34. A locking member, such as a screw (not shown), is inserted into the second locking hole 34 and the securing hole 541 to secure the mounting plate 50 to the cover 30. The cover 30 is moved to the chassis 10 with the first locking hole 32 aligned with the first mounting hole 131 and the second mounting hole 141. The cover 30 is locked to the installation plate 13 and the connecting plate 14 by other locking members. In this position, the hard disk drive 40 is mounted on the chassis 10, and the cover 30 is located above the hard disk drive 40 and the two circuit boards 20. Components including the connector 22 are protected below the cover 30, preventing the components from being scratched or damaged.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and the arrangement of parts within the principles of the disclosure, to the full extent indicated by the broad general meaning of the terms in which the appended claims are expressed.

What is claimed is:

1. An electronic device, comprising:
a chassis;
a circuit board mounted in the chassis;
a hard disk drive comprising a sidewall;
a cover secured to the chassis and covering the circuit board; and
a mounting plate secured to the sidewall and securing the hard disk drive to the cover adjacent to the circuit board.

2. The electronic device of claim 1, wherein the chassis comprises a bottom plate, two side plates extending from the bottom plate, an installation plate connected between the two side plates, and a connecting plate extending from the bottom plate; the installation plate is substantially parallel to the connecting plate and substantially perpendicular to the two side plates; and the circuit board and the hard disk drive are located between the installation plate and the connecting plate.

3. The electronic device of claim 2, wherein a length of the cover is substantially equal to a distance between the installation plate and the connecting plate, and a width of the cover is substantially equal to a width of the connecting plate.

4. The electronic device of claim 2, wherein each of opposite sides of the cover defines a first locking hole; the connecting plate defines a first mounting hole; the installation plate defines a second mounting hole; each of the first mounting hole and the second mounting hole is aligned with the first locking hole; and the cover is secured to the installation plate and the connecting plate.

5. The electronic device of claim 2, wherein the circuit board is secured to the bottom plate and located between the installation plate and the connecting plate.

6. The electronic device of claim 1, wherein the hard disk drive further comprises a top wall perpendicularly connected to the sidewall, and an area of the cover is greater than an area of the top wall.

7. The electronic device of claim 1, wherein the mounting plate comprises a main body secured to the sidewall and a mounting piece extending from the main body, and the mounting piece is secured to the cover.

8. The electronic device of claim 7, wherein the mounting piece comprises a first portion extending from a side edge of the main body and a second portion extending from a top edge of the first portion, and the second portion is secured to the cover.

9. The electronic device of claim 7, wherein a length of the mounting plate is substantially equal to a length of the sidewall, and the mounting piece does not touch the hard disk drive.

10. The electronic device of claim 1, further comprising a mounting member and a shock absorbing member, wherein the sidewall defines an installation hole; the mounting plate defines an installation slot; and the mounting member is engaged in the installation hole through the shock absorbing member and the installation slot to secure the mounting plate to the sidewall.

11. An electronic device, comprising:
a chassis comprising an installation plate and a connecting plate substantially parallel to the installation plate;
a circuit board mounted in the chassis between the installation plate and the connecting plate;
a hard disk drive comprising a sidewall;
a cover secured to the installation plate and the connecting plate and covering the circuit board and the hard disk drive; and
a mounting plate secured to the sidewall and securing the hard disk drive to the cover adjacent to the circuit board.

12. The electronic device of claim 11, wherein the chassis further comprises a bottom plate and two side plates extending from the bottom plate; the installation plate is connected between the two side plates, and the connecting plate extends from the bottom plate; the installation plate is substantially perpendicular to the two side plates; and the circuit board and the hard disk drive are located between the installation plate and the connecting plate.

13. The electronic device of claim 11, wherein a length of the cover is substantially equal to a distance between the installation plate and the connecting plate, and a width of the cover is substantially equal to a width of the connecting plate.

14. The electronic device of claim 11, wherein each of opposite sides of the cover defines a first locking hole; the connecting plate defines a first mounting hole; the installation plate defines a second mounting hole; each of the first mounting hole and the second mounting hole is aligned with the first locking hole; and the cover is secured to the installation plate and the connecting plate.

15. The electronic device of claim 12, wherein the circuit board is secured to the bottom plate and located between the installation plate and the connecting plate.

16. The electronic device of claim 11, wherein the hard disk drive further comprises a top wall perpendicularly connected to the sidewall, and an area of the cover is greater than an area of the top wall.

17. The electronic device of claim 11, wherein the mounting plate comprises a main body secured to the sidewall and a mounting piece extending from the main body, and the mounting piece is secured to the cover.

18. The electronic device of claim 17, wherein the mounting piece comprises a first portion extending from a side edge of the main body and a second portion extending from a top edge of the first portion; and the second portion is secured to the cover.

19. The electronic device of claim 17, wherein a length of the mounting plate is substantially equal to a length of the sidewall, and the mounting piece does not touch the hard disk drive.

20. The electronic device of claim 11, further comprising a mounting member and a shock absorbing member, wherein the sidewall defines an installation hole; the mounting plate defines an installation slot; and the mounting member is engaged in the installation hole through the shock absorbing member and the installation slot to secure the mounting plate to the sidewall.
